(19) United States
(12) Patent Application Publication
(10) Pub. No.: US 2017/0114628 A1
(43) Pub. Date: Apr. 27, 2017

(54) SLICKLINE DEPLOYED CASING INSPECTION TOOLS

(71) Applicant: HALLIBURTON ENERGY SERVICES, INC., Houston, TX (US)

(72) Inventors: Reza Khalaj Amineh, Houston, TX (US); Burkay Donderici, Houston, TX (US); Sushovon Singha Roy, Houston, TX (US)

(73) Assignee: HALLIBURTON ENERGY SERVICES, INC., Houston, TX (US)

(21) Appl. No.: 14/889,237

(22) PCT Filed: Jun. 23, 2015
(86) PCT No.: PCT/US2015/037205

§ 371 Date: Nov. 5, 2015

Related U.S. Application Data
(60) Provisional application No. 62/023,594, filed on Jul. 11, 2014.

(51) Int. Cl. E21B 47/00; E21B 47/08; G01B 7/06; E21B 47/09

(52) U.S. Cl. CPC E21B 47/0006; E21B 47/0905; E21B 47/082; G01B 7/06

(57) ABSTRACT

Methods of lowering a casing inspection tool on a conveyance into a wellbore lined with one or more casings. Measurement data is then obtained from the one or more casings with one or more electromagnetic sensors positioned on the casing inspection tool. One or more characteristics of the one or more casings is then determined based on the measurement data with a processing module positioned on the casing inspection tool. One or more parameters of the casing inspection tool are then autonomously adjusted based on the one or more characteristics.

### CROSS-REFERENCE TO RELATED APPLICATIONS

The present application claims priority to U.S. Provisional Patent App. Ser. No. 62/023,594, filed on Jul. 11, 2014.

### BACKGROUND

Wellbores in the oil and gas industry are typically drilled using a drill string with a drill bit secured to its distal end. The drilled wellbore is subsequently completed by cementing a string of metal pipes commonly called “casing” within the wellbore. The casing increases the integrity of the wellbore and provides a flow path between the earth's surface and selected subterranean formations. The pipes that make up the casing may be made of plain carbon steel, stainless steel, or another material able to withstand a variety of forces, such as collapse, burst, and tensile failure. During the lifetime of a well, the casing is exposed to high volumes of materials and fluids required to pass through it, including chemically aggressive fluids. In harsh environments, however, the casing may be subject to corrosion that may affect its functionality. Consequently, the structural integrity of the casing may change over time due to chemical and mechanical interactions.

Electromagnetic (EM) sensing provides continuous, in situ measurements of parameters related to the integrity of casing that lines a wellbore. As a result, there has been considerable interest in using EM in cased borehole monitoring applications. In conventional electromagnetic (EM) casing inspection tools, transmitter coils emit continuous sine waves (corresponding to single-frequency or multi-frequency excitations) or pulse signals, and the receiver coil, which can sometimes be the same coil that transmits the signal, records the responses. When such tools are placed inside cased boreholes, any changes in the number or thickness of the casing will cause a change in induced electromotive force in the receiver coil. After processing the signals generated by the receiver, defects (e.g., corrosion), fractures, holes, and wall thickness of casings can be determined.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is a partial cross-sectional side view of a prior art casing inspection tool.

FIG. 2 is a partial cross-sectional side view of an exemplary casing inspection tool of the present disclosure.

FIG. 3A shows a schematic diagram of one embodiment of the location marking device of FIG. 2.

FIG. 3B shows a schematic diagram of another embodiment of the location marking device of FIG. 2.

FIG. 4 is a schematic flow chart of an exemplary method of operating the casing inspection tool of FIG. 2.

FIG. 5 is a schematic diagram of a processing method for the processing module of FIG. 2.

FIG. 6 is a schematic flow chart of an inversion method that may be applied by the processing module of FIG. 2.

### DETAILED DESCRIPTION

The present disclosure is related to wellbore inspection techniques for the oil and gas industry and, more particularly, to monitoring and evaluating corrosion in wellbore completion components, such as casing strings, with electromagnetic inspection tools and downhole logging to make autonomous decisions based on the measurements.

The embodiments discussed herein describe a combination of electromagnetic casing inspection tools and downhole logging techniques to make autonomous decisions based on measurements obtained by the casing inspection tools. The presently described casing inspection tools may be capable of recording acquired measurement data from one or more electromagnetic sensors and other sensors on a memory, and may then subsequently make autonomous decisions based on the measurement data. Proper processing algorithms implemented by the casing inspection tools allow for controlling the electromagnetic sensors to minimize the power consumption or proper actions can be implemented while performing the logging, such as marking defected regions of the casing(s) or refining the sampling of acquired responses in the defected regions. As a result, the presently described systems and methods provide more efficient electromagnetic inspection of wellbore casings in terms of time and cost. It should be noted that the terms “casing” and “pipe” as used herein may be used interchangeably.

Various types of electromagnetic inspection tools have been introduced to detect the integrity of wellbore pipes, such as casing, including detection of one or more additional strings of casing concentrically-positioned about an inner string of casing. A multi-frequency inspection tool, for instance, has been proposed and provides an estimate of the inner diameter and average properties of the inner casing (i.e., the first pipe), as well as the total thickness of additional multiple casings concentrically-positioned about the first casing. A pulse eddy current (time-domain) inspection tool has also been proposed and employs multiple (long, short, and transversal) coil antennas to evaluate multiple types of defects in double pipes (i.e., two strings of casing or pipes that are concentrically arranged). Both of these tools are run downhole using wireline or electric line (i.e., “e-line”), which supplies power to the inspection tool and provides a communication link for the tool.

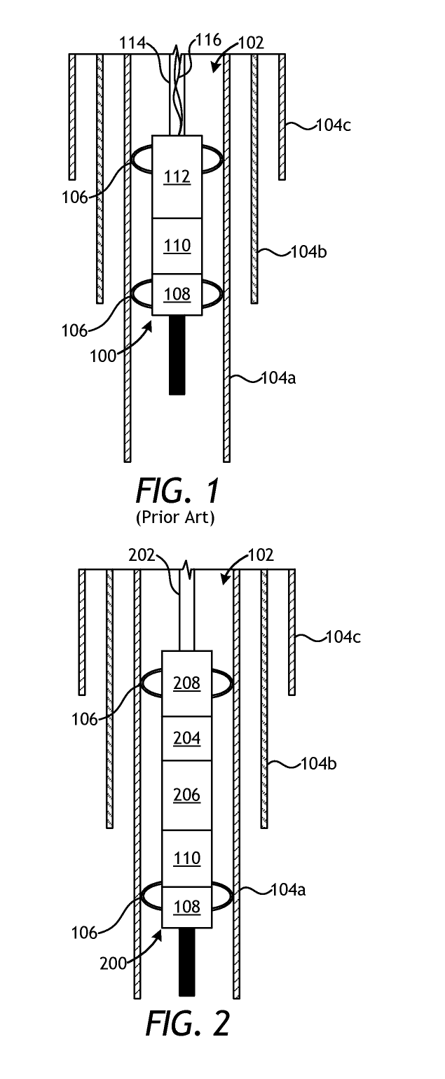

FIG. 1 is a partial cross-sectional side view of a prior art casing inspection tool 100. The casing inspection tool 100 is shown deployed in a wellbore 102 lined with multiple strings of casing 104, shown as a first casing 104a, a second casing 104b, and a third casing 104c. Each casing 104a-c may comprise multiple pipe lengths coupled end-to-end and positioned within the wellbore 102 in a generally concentric relationship. The first casing 104a is shown concentrically-located within the second casing 104b, and the second casing 104b is shown concentrically-located within the third casing 104c. Each casing 104a-c may comprise pipe made of plain carbon steel, stainless steel, or another material capable of withstanding a variety of forces, such as collapse, burst, and tensile failure. While three strings of casing 104a-c are depicted in FIG. 1A, it will be appreciated that more or less than three may be employed (including only the first casing 104a) in the presently disclosed embodiments.

One or more centralizers 106 are used to position the body of the casing inspection tool 100 at the center of the first casing 104a. The casing inspection tool 100 further includes one or more electromagnetic sensors 108, one or more wellbore parameter sensors 110, and a communication module 112. The electromagnetic sensors 108 may include one or more electromagnetic transmitters and receivers (or transceivers) used to obtain in situ measurements of the casings 104a-c to help determine the integrity of each casing 104a-c. In some embodiments, the electromagnetic sensors 108 may be designed to operate in a centralized position within the first casing 104a. In other embodiments, however, the electromagnetic sensors 108 may be designed to be in intimate contact with the first casing 104a. In such embodiments, the electromagnetic sensors 108 may be mounted on one or more deployable sensor pads (not expressly shown) and hydraulically actuated back-up arms (not expressly shown) that move the electromagnetic sensors 108 radially adjacent or otherwise in direct contact with the inner wall of the first casing 104a.

The electromagnetic transmitters and receivers (or transceivers) of the electromagnetic sensors 108 may comprise one or more short coil antennas and/or one or more long coil antennas for monitoring the casings 104a-c at various radial depths away from the casing inspection tool 100. The shorter coil antennas may prove useful in monitoring the first and possibly the second casings 104a,b, and the longer coil antennas may prove useful in monitoring the outer casings, such as the third casing 104c. Longer coil antennas could be used for monitoring the inner pipes as well, but with decreased resolution and larger transmitted power as compared to shorter coil antennas. Any changes in the number or thickness (i.e., an indication of a defect, such as corrosion) of the casings 104a-c will cause a change in induced electromotive forces detected by the receivers of the electromagnetic sensors 108. After processing the receiver signals, defects (e.g., corrosion), fractures, holes, wall thickness, and other characteristics of the casings 104a-c can be determined.

The wellbore parameter sensors 110 can include, for example, one or more temperature sensors, pressure sensors, gamma ray sensors, etc. used to continuously or intermittently monitor conditions within the wellbore 102. The electromagnetic sensors 108 and the wellbore parameter sensors 110 may be communicably coupled to the communication module 112, which is able to communicate with a surface location (e.g., a computer located at the earth's surface either on site or at a remote location) via a wireline 114 operatively coupled to the casing inspection tool 100. As illustrated, the wireline 114 may include one or more communication lines 116 that place the casing inspection tool 100 in communication with the surface location. The wireline 114 is used to convey the casing inspection tool 100 into the wellbore 102, and the communication lines 116 provide power to the casing inspection tool 100 and a means of communicating signals between the casing inspection tool 100 and the surface location. The communication lines 116 can include, for example, one or more electrical conductors, electrical wires, fiber optic lines, or any other wired telecommunication means capable of communicating a signal from the casing inspection tool 100 to the surface location.

FIG. 2 is a partial cross-sectional side view of an exemplary casing inspection tool 200, according to one or more embodiments of the present disclosure. The casing inspection tool 200 may be similar in some respects to the casing inspection tool 100 of FIG. 1 and therefore may be best understood with reference thereto, where like numerals represent like components or elements that may not be described again in detail. Similar to the casing inspection tool 100 of FIG. 1, for example, the casing inspection tool 200 may be deployed in the wellbore 102 lined with the three (or more or less) strings of casing 104a-c. Moreover, the casing inspection tool 200 may also include the centralizers 106, the electromagnetic sensors 108, and the wellbore parameter sensors 110, as generally described above.

Unlike the casing inspection tool 100 of FIG. 1, however, the casing inspection tool 200 may be conveyed into the wellbore 102 via any type of conveyance 202 extended from the earth's surface and coupled to the body of the casing inspection tool 200. In some embodiments, for instance, the conveyance may comprise slickline, which generally encompasses a thin, non-electric cable or wire used to run the casing inspection tool 200 (or other downhole tools) into the wellbore 102 without supplying any power or communication link. In other embodiments, however, the conveyance 202 may comprise slickline or any other downhole cable that includes one or more communication lines embedded therein to communicate with the casing inspection tool 200, similar to the communication lines 116 of FIG. 1 (e.g., one or more of an electrical conductor, an electrical wire, an optical fiber, etc.), without departing from the scope of the disclosure. The conveyance 202 can be made of a variety of materials including, but not limited to, stainless steel or other metals and metal alloy materials, a polymer, and a fiber-reinforced polymer composite-based material.

At the Earth's surface, the conveyance 202 as slickline may be deployed from a slickline unit (not shown), which may include a reel and a lubricator. The conveyance 202 may be wound about the reel and deployed into the lubricator, which provides pressure isolation from the wellbore 102, but simultaneously allows the casing inspection tool 200 and the conveyance 202 to progressively traverse the wellbore 102. The slickline unit may also provide a winch for running the casing inspection tool 200 in and out of the wellbore 102, and the depth of the casing inspection tool 200 can thereby be recorded. Once the desired wellbore operations are accomplished, as discussed below, the casing inspection tool 200 may be retracted to the earth's surface and the conveyance 202 may be wound back onto the reel. Accordingly, the conveyance 202 may essentially serve as a tether for the casing inspection tool 200, and may or may not provide any power or communication link for the casing inspection tool 200.

As illustrated, the casing inspection tool 200 may include a power source 204, a processing module 206, and a location marking device 208. The power source 204 may be configured to provide the power required to operate the casing inspection tool 200 downhole. More particularly, the power source 204 may be communicably coupled to and configured to selectively provide power to each of the electromagnetic sensors 108, the wellbore parameter sensors 110, the processing module 206, and the location marking device 208. The power source 204 may comprise a variety of power storage devices including, but not limited to, one or more batteries, a fuel cell, and a capacitive bank.

The processing module 206 may comprise a computer system that includes one or more processors and a memory configured to receive and store data. The memory may be any non-transitory machine-readable medium that has stored therein at least one computer program with executable instructions that cause the processor(s) to perform one or more actions. The memory may be, for example, random access memory (RAM), flash memory, read only memory (ROM), programmable read only memory (PROM), electrically erasable programmable read only memory (EEPROM), registers, hard disks, removable disks, a CD-ROM, a DVD, any combination thereof, or any other suitable storage device or medium. In some embodiments, data obtained from one or both of the electromagnetic and wellbore parameter sensors 108, 110 may be stored in the memory to be accessed upon returning the casing inspection tool 200 to the surface location. In other embodiments, however, the data obtained from one or both of the electromagnetic and wellbore parameter sensors 108, 110 may be processed by the processing module 208, which may be configured to autonomously undertake one or more actions based on the processed measurement data.

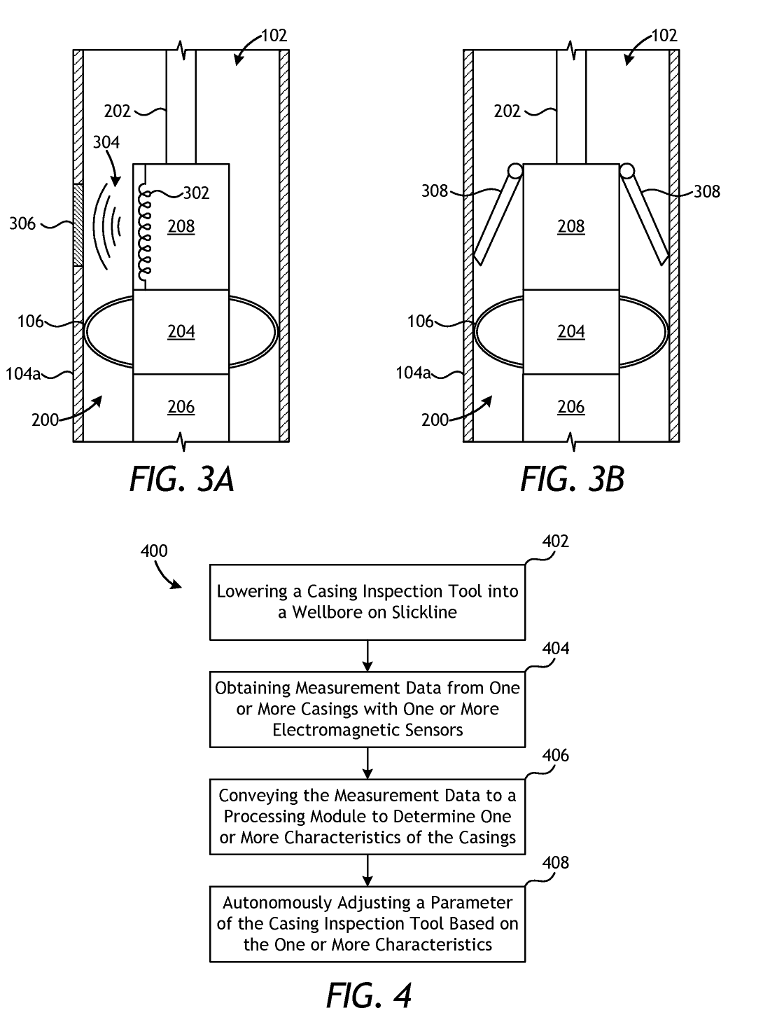

One action that may be autonomously undertaken by the processing module 206 upon processing the measurement data includes activating the location marking device 208, which may be configured to mark a designated portion of the wellbore 102 for future reference or send a signal to the surface via changing the tension of the conveyance 202. This helps to record the corresponding depth or change the logging speed. FIG. 3A shows a schematic diagram of one embodiment of the location marking device 208, which may comprise a magnetic marking device configured to magnetize the casing 104a at a desired location within the wellbore 102 upon being activated by the processing module 206. To magnetically mark the casing 104a, a current may be applied from the power source 204 to an electromagnet 302, which emits a strong magnetic flux 304 that creates a permanent magnetic mark 306 in the casing 104a. The magnetic mark 306 may be subsequently detected on a later run into the wellbore 102 by a conventional casing collar locator, for example, or another type of magnetic sensing device. Upon locating the magnetic mark 306, a desired remedial operation on one or more of the casings 104a-c may be undertaken at that location within the wellbore 102. As will be appreciated, magnetic marks 306 can be applied at a variety of axial and/or azimuthal locations along/around the casing 104a.

FIG. 3B shows a schematic diagram of another embodiment of the location marking device 208, which may include one or more caliper arms 308 (two shown) that may be actuatable to engage the inner wall of the casing 104a and thereby send a signal to the surface location for proper current actions (such as lowering the logging speed and collect more samples) or recording the depth for future reference. More particularly, the caliper arms 308 may be extended outward to engage the casing 104a upon receiving a signal provided by the processing module 204. Engaging the inner wall of the casing 104a may result in an increase in the tension of the conveyance 202, which may be detected at the surface location using suitable sensors. Upon measuring the increased tension of the conveyance 202, an operator may be apprised of a particular location within the wellbore 102 where a problem may exist or where one or more actions should be undertaken.

FIG. 4 is a schematic flow chart of an exemplary method 400 of operating the casing inspection tool 200 of FIG. 2, according to one or more embodiments. As illustrated, the method 400 may include lowering the casing inspection tool 200 into the wellbore 102 (FIG. 2) on the conveyance 202 (FIG. 2), as at 402. As indicated above, the wellbore 102 may be lined with one or more casings 104a-c (FIG. 2). Once in the wellbore 102, the electromagnetic sensors 108 may proceed to obtain measurement data from one or more of the casings 104a-c, as at 404. The measurement data may be acquired by the electromagnetic sensors 108 along the axial and/or azimuthal directions within the wellbore 102. In some embodiments, the measurement data may be obtained continuously as the casing inspection tool 200 is lowered into the wellbore 102. In other embodiments, however, the measurement data may comprise sampled data selectively obtained over a limited portion of the casings 104a-c.

In some embodiments some or all of the measurement data may be stored in the memory of the processing module 206 (FIG. 2) for subsequent download and analysis. In other embodiments, however, the measurement data may be conveyed to the processing module 206 for processing where a determination of one or more characteristics of the casings 104a-c at that particular axial location within the wellbore 102 may be made, as at 406. The one or more characteristics of the casings 104a-c at the particular axial location within the wellbore 102 may include, but are not limited to, the number of casings 104a-c in the wellbore 102, the dimensions (i.e., diameter, wall thickness, etc.) of the casings 104a-c, and the presence of a defect in the casings 104a-c.

The method 400 may further include autonomously adjusting one or more parameters of the casing inspection tool 200 based on the one or more characteristics of the casings 104a-c determined by the processing module 206, as at 408. In one embodiment, for example, the characteristic determined by the processing module 206 may be the number of casings 104a-c, their nominal thickness, and their electrical properties at that particular axial location in the wellbore 102. Based on how many casings 104a-c are detected and their overall thickness, the processing module 206 may make an autonomous decision for further operation of the casing inspection tool 200. For example, when it is determined that the casing inspection tool 200 is inspecting only the first casing 104a or the overall thickness of the pipes is small, the processing module 206 may autonomously deactivate (i.e., switch off) the longer coil antennas of the electromagnetic sensors 108, which are more apt to monitoring the second and third casings 104b,c or larger overall thickness of the pipes. Alternatively, or in addition thereto, the processing module 206 may autonomously decrease the power output emitted by the electromagnetic sensors 108. As can be appreciated, this may facilitate enormous power savings for the casing inspection tool 200, which can be vital in saving the stored energy of the power source 204 necessary for conveyance 202 deployment.

In other embodiments, the one or more characteristics determined by the processing module 206 may reveal at least one defect in one of the casings 104a-c. Detectable defects in the casings 104a-c include, but are not limited to, corrosion, fractures, holes, and decreased wall thickness. In some embodiments, a detectable defect in the casing 104a-c may also include corrosion or other problems related to a perforation defined in the wall of the casings 104a-c to provide a fluid path for hydrocarbons to enter the wellbore 102. Upon determining that a defect is present in one or more of the casings 104a-c (or a perforation), the processing module 206 may be configured to activate the location marking device 208 (FIGS. 2 and 3A-3B) for proper actions such as lowering the logging speed for collecting more samples or for future reference. As indicated above, marking the casings 104a-c with the location marking device 208 may serve to pinpoint a location within the wellbore 102 where proper actions can be implemented according to the condition or remedial work on detected defect may be undertaken at a later time.

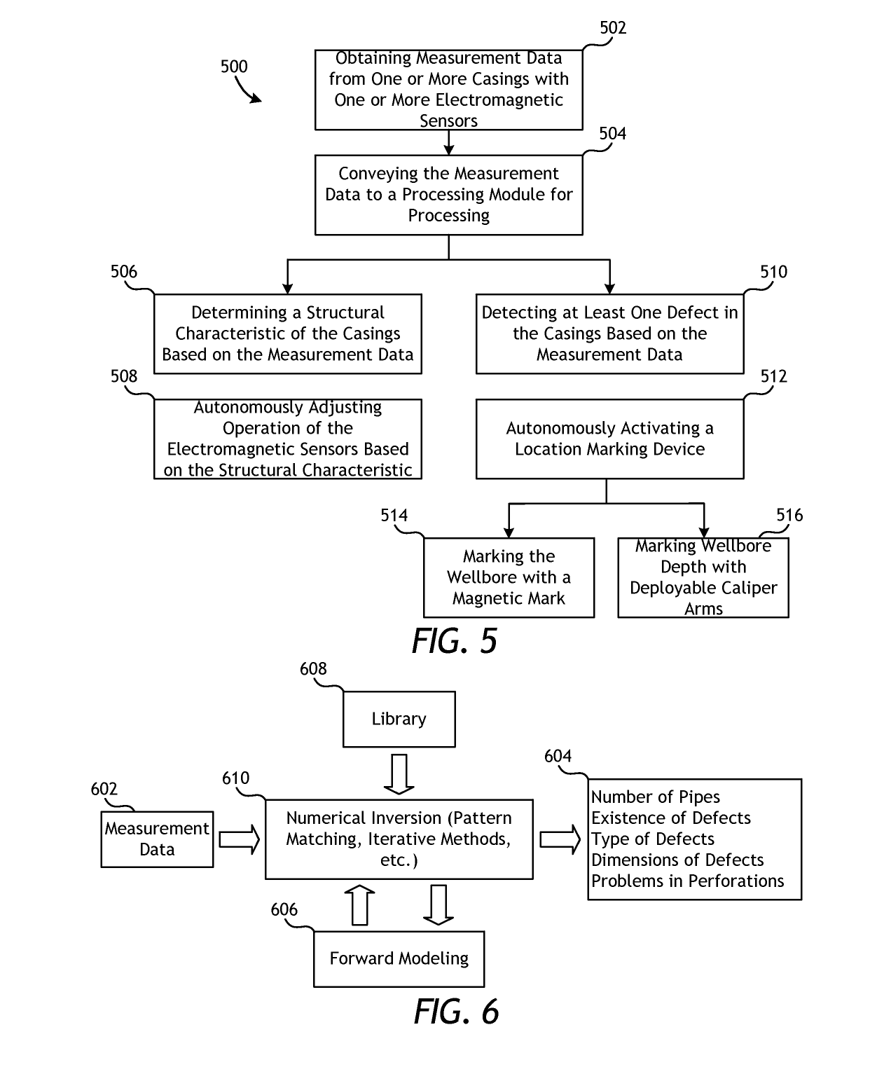

Referring to FIG. 5, illustrated is a schematic diagram of a processing method 500 for the processing module 206 of FIG. 2, according to one or more embodiments. In the processing method 500, measurement data from the casings 104a-c (FIG. 2) may be obtained with the electromagnetic sensors 108 (FIG. 2) along axial and/or azimuthal directions within the wellbore 102 (FIG. 2), as at 502. The measurement data may then be conveyed to the processing module 206 for processing, as at 504. Some operations that can be applied once the measurement data is acquired by the electromagnetic sensors 108 and conveyed to the processing module 206 include, but are not limited to, filtering the data to reduce noise; averaging multiple sensor data to reduce noise; taking the difference or the ratio of multiple voltages to remove unwanted effects, such as a common voltage drift due to temperature; undertaking other temperature correction schemes, such as a temperature correction table; calibrating the casing inspection tool 200 to known/expected parameter values from an existing well log; and undertaking array processing (software focusing) of the measurement data to achieve different depth of detection or vertical/azimuthal resolution. The aforementioned operations are well-known in the field of EM well logging and, therefore, their details are not provided here.

In some embodiments, the processing module 206 determines a structural characteristic of the casings 104a-c at that particular axial location within the wellbore 102 based on the measurement data, as at 506. One structural characteristic of the casings 104a-c that may be determined based on the measurement data is a determination of the number of casings 104a-c. Other structural characteristics of the casings 104a-c that may be determined based on the measurement data are a determination of a diameter of each of the casings 104a-c, its nominal thickness, and its electrical properties. Based on the structural characteristics of the casings 104a-c, the processing module 206 may then proceed to autonomously adjust operation of the electromagnetic sensors 108, as at 508. For instance, when it is determined that only the first casing 104a is present in the wellbore 102 or the overall thickness of the pipes is small at that particular axial location, the processing module 206 may proceed to autonomously deactivate (i.e., switch off) the longer coil antennas of the electromagnetic sensors 108 (both transmitters and receivers), which are more apt to monitor the second and third casings 104b,c or larger overall thickness of the pipes. Alternatively, or in addition thereto, the processing module 206 may autonomously decrease the power output emitted by the electromagnetic sensors 108. As will be appreciated, inspecting only the first casing 104a at a smaller diameter or inspecting multiple pipes with smaller overall thickness requires only the shorter coil antennas, and lower signal strength (i.e., lower power) can be employed to conserve battery power of the power source 204 (FIG. 2). These actions may lead to efficient use of the transmitters and receivers in effectively characterizing the casings 104a-c.

In other embodiments, however, the measurement data conveyed to and processed by the processing module 206 may result in the detection of at least one defect in one or more of the casings 104a-c at that particular axial and/or azimuthal location in the wellbore 102, as at 510. As indicated above, a detectable defect in the casings 104a-c may include corrosion, fractures, holes, and decreased wall thickness of the casings 104a-c, but may also include problems related to a perforation defined in the wall of the casings 104a-c.

Upon determining that a defect is present in one or more of the casings 104a-c (or a perforation), the processing module 206 may be configured to autonomously activate the location marking device 208 (FIGS. 2 and 3A-3B) to mark the wellbore 102 at that location or send a signal to the surface via the conveyance 202 (FIG. 2) for proper current actions or for future reference, as at 512. In embodiments where the location marking device 208 is a magnetic marking device, as described above with reference to FIG. 3A, the location marking device 208 may mark the wellbore 102 with a magnetic mark 306 (FIG. 3A), as at 514. The magnetic mark 206 may be subsequently detectable by a conventional casing collar locator or another type of magnetic sensing device. In embodiments where the location marking device 208 includes one or more deployable caliper arms 308, as described above with reference to FIG. 3B, the location marking device 208 may deploy the caliper arms 308 to engage the inner wall of the first casing 104a and thereby send a signal to the surface via the conveyance 202. As described above, engaging the caliper arms 308 against the inner wall of the first casing 104a may increase the tension of the conveyance 202, which may be detected at the surface and signal the existence of the defected region to a well operator. Accordingly, each marking action undertaken by the location marking device 208 may serve to pinpoint a location within the wellbore 102 where proper actions can be implemented according to the condition or remedial work may be undertaken at a later time. For instance, if the caliper arms 308 are employed, the well operator can then perform finer sampling of the defected region(s), if desired, which may result in more precise characterization of the flawed region.

Referring now to FIG. 6, illustrated is a schematic flow chart of an inversion method 600 that may be applied by the processing module 206 of FIG. 2, according to one or more embodiments of the present disclosure. The inversion method 600 may prove useful in converting the frequency-domain or time-domain measurement data 602 derived from the electromagnetic sensors 108 (FIG. 2) to one or more characteristics 604 of the casings 104a-c (FIG. 2). Performing an inversion operation may include using forward model 606 and/or a library 608. The forward model 606 provides a set of mathematical relationships for sensor responses that can be applied to determining what a selected sensor would measure when monitoring a particular casing or pipe with or without a particular defect. The library 608 may include information regarding various casing characteristics that can be correlated to measured responses from selected antenna signals.

A numerical inversion operation 610 may entail performing an iterative process and/or undertaking a pattern matching process. In particular, the numerical inversion 610 may be performed by iteratively comparing signals of the measurement data 602 with values obtained by the forward model 606 or otherwise stored in the library 608. In at least one example of iterative use of the forward model 606, an initial value or guess of a characteristic (e.g., the number of casings) and a forward model may be applied to the initial value. The forward model provides a response, and the response is compared with a measured value and a next guess is generated based on the comparison. The comparison process continues to adjust the guess until the values of the forward model and the measured results agree.

The library 608 can be used with a pattern-matching inversion process. The library 608 may include correspondences between a physical measurement and a property or an identification of the nature of a physical entity (i.e., a casing) that generated a particular electromagnetic field in response to a sensor signal. For example, measurement of a specific voltage or field can be mapped to a specific type of casing, casing dimension, or defect (i.e., corrosion). By comparing the measured value with a library including such values, a characteristic of the casing, such as casing number dimension, or a defect can be obtained from the library by the matching process. In some embodiments, a pattern of measured voltages can be matched to voltages in the library 608 to identify the desired characteristic 604. Outputs from the numerical inversion 610 can include the characteristics 604 associated with the casings 104a-c (FIG. 2), such as the number of casings, the existence of a defect in the casing(s), the type of defect, the dimensions of a defect, and/or a problem in a perforation defined in the casings.

Effects due to the presence of the housing for the electromagnetic sensors 108 (FIG. 2), a pad structure (if used) that houses the electromagnetic sensors 108, the mutual coupling between the electromagnetic sensors 108, mud, and cement can all be corrected by using a priori information on these characteristics 604, or by solving for some or all of them during the inversion method 600. Since all of these effects are mainly additive, they may be removed using proper calibration schemes. The multiplicative (scaling) portion of the effects can also be removed in the process of calibration to an existing log. All additive, multiplicative, and any other non-linear effect can be solved for by including them in the numerical inversion operation 610 as a parameter. Removal of such effects is well-known in EM well logging and, therefore, are not described in detail here.

Embodiments disclosed herein include:

A. A method that includes lowering a casing inspection tool on a conveyance into a wellbore lined with one or more casings, obtaining measurement data from the one or more casings with one or more electromagnetic sensors positioned on the casing inspection tool, determining one or more characteristics of the one or more casings based on the measurement data with a processing module positioned on the casing inspection tool, and autonomously adjusting one or more parameters or actions of the casing inspection tool based on the one or more characteristics.

B. A casing inspection tool that includes a body attached to a conveyance for running the casing inspection tool into a wellbore lined with one or more casings, one or more electromagnetic sensors positioned on the body, a location marking device positioned on the body, a processing module positioned on the body and communicably coupled to the one or more electromagnetic sensors and the location marking device, and a power source positioned on the body and providing power to the one or more electromagnetic sensors, the location marking device, and the processing module, wherein the processing module is programmed to determine one or more characteristics of the one or more casings based on measurement data received by the one or more electromagnetic sensors and autonomously adjust one or more parameters or actions of the casing inspection tool based on the one or more characteristics.

Each of embodiments A and B may have one or more of the following additional elements in any combination: Element 1: further comprising obtaining the measurement data with the one or more electromagnetic sensors along an axial direction within the wellbore. Element 2: further comprising obtaining the measurement data with the one or more electromagnetic sensors along an azimuthal direction within the wellbore. Element 3: wherein determining the one or more characteristics of the one or more casings includes determining at least one of a number of the one or more casings, a dimension of the one or more casings, and a presence of a defect in the one or more casing. Element 4: further comprising powering the one or more electromagnetic sensors and the processing module with a power source positioned on the casing inspection tool. Element 5: wherein the one or more characteristics comprises a number or dimension of the one or more casings at a particular axial location in the wellbore, and autonomously adjusting the one or more parameters of the casing inspection tool comprises deactivating at least one of the one or more electromagnetic sensors. Element 6: wherein the one or more characteristics comprises a number or dimension of the one or more casings at a particular axial location in the wellbore, and autonomously adjusting the one or more parameters of the casing inspection tool comprises decreasing a power output emitted by the one or more electromagnetic sensors. Element 7: wherein the one or more characteristics comprises a defect present in at least one of the one or more casings, and autonomously adjusting the one or more parameters or actions of the casing inspection tool comprises activating with the processing module a location marking device positioned in the casing inspection tool, and marking the wellbore with the location marking device at a location corresponding to the defect. Element 8: wherein the location marking device is a magnetic marking device and marking the wellbore with the location marking device comprises marking the wellbore with a magnetic mark. Element 9: wherein the location marking device includes one or more caliper arms and marking the wellbore with the location marking device comprises deploying the one or more caliper arms to engage an inner wall of the one or more casings, and detecting an increase in a tension in the conveyance at a surface location as the one or more caliper arms engage the inner wall of the one or more casings, whereby the increase in the tension signals a location of the defect in the wellbore. Element 10: further comprising undertaking finer sampling of the wellbore at the location corresponding to the defect. Element 11: further comprising inverting values of the measurement data with the processing module to transform the values into the one or more characteristics.

Element 12: wherein the processing module comprises a computer system that includes one or more processors and a memory that has stored therein at least one computer program with executable instructions that cause the one or more processors to determine the one or more characteristics of the one or more casings based on the measurement data and autonomously adjust the one or more parameters of the casing inspection tool based on the one or more characteristics. Element 13: wherein the location marking device comprises a magnetic marking device that creates a permanent magnetic mark in the one or more casings. Element 14: wherein the location marking device includes one or more caliper arms that are actuatable to engage an inner wall of the one or more casings. Element 15: further comprising one or more centralizers attached to the body. Element 16: wherein the one or more characteristics of the one or more casings comprises a defect in the one or more casings selected from the group consisting of corrosion, a fracture, a hole, decreased wall thickness, and corrosion of a perforation defined in a wall of at least one of the one or more casings. Element 17: wherein the one or more characteristics comprises a structural characteristic of the one or more casings selected from the group consisting of a number of the one or more casings, and a diameter of at least one of the one or more casings. Element 18: wherein the processing module is further programmed to autonomously deactivate at least one of the one or more electromagnetic sensors or autonomously decrease the power output emitted by the one or more electromagnetic sensors upon determining the structural characteristic of the one or more casings.

By way of non-limiting example, exemplary combinations applicable to A and B include: Element 7 with Element 8; Element 7 with Element 9; Element 9 with Element 10; and Element 17 with Element 18.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A method, comprising:
lowering a casing inspection tool on a conveyance into a wellbore lined with one or more casings;
obtaining measurement data from the one or more casings with one or more electromagnetic sensors positioned on the casing inspection tool;
determining one or more characteristics of the one or more casings based on the measurement data with a processing module positioned on the casing inspection tool; and
autonomously adjusting one or more parameters or actions of the casing inspection tool based on the one or more characteristics.

2. The method of claim 1, further comprising obtaining the measurement data with the one or more electromagnetic sensors along an axial direction within the wellbore.

3. The method of claim 1, further comprising obtaining the measurement data with the one or more electromagnetic sensors along an azimuthal direction within the wellbore.

4. The method of claim 1, wherein determining the one or more characteristics of the one or more casings includes determining at least one of a number of the one or more casings, a dimension of the one or more casings, and a presence of a defect in the one or more casing.

5. The method of claim 1, further comprising powering the one or more electromagnetic sensors and the processing module with a power source positioned on the casing inspection tool.

6. The method of claim 1, wherein the one or more characteristics comprises a number or dimension of the one or more casings at a particular axial location in the wellbore, and autonomously adjusting the one or more parameters of the casing inspection tool comprises deactivating at least one of the one or more electromagnetic sensors.

7. The method of claim 1, wherein the one or more characteristics comprises a number or dimension of the one or more casings at a particular axial location in the wellbore, and autonomously adjusting the one or more parameters of the casing inspection tool comprises decreasing a power output emitted by the one or more electromagnetic sensors.

8. The method of claim 1, wherein the one or more characteristics comprises a defect present in at least one of the one or more casings, and autonomously adjusting the one or more parameters or actions of the casing inspection tool comprises:
activating with the processing module a location marking device positioned in the casing inspection tool; and
marking the wellbore with the location marking device at a location corresponding to the defect.

9. The method of claim 8, wherein the location marking device is a magnetic marking device and marking the wellbore with the location marking device comprises marking the wellbore with a magnetic mark.

10. The method of claim 8, wherein the location marking device includes one or more caliper arms and marking the wellbore with the location marking device comprises:
deploying the one or more caliper arms to engage an inner wall of the one or more casings; and
detecting an increase in a tension in the conveyance at a surface location as the one or more caliper arms engage the inner wall of the one or more casings, whereby the increase in the tension signals a location of the defect in the wellbore.

11. The method of claim 10, further comprising undertaking finer sampling of the wellbore at the location corresponding to the defect.

12. The method of claim 1, further comprising inverting values of the measurement data with the processing module to transform the values into the one or more characteristics.

13. A casing inspection tool, comprising:
a body attached to a conveyance for running the casing inspection tool into a wellbore lined with one or more casings;
one or more electromagnetic sensors positioned on the body;
a location marking device positioned on the body;
a processing module positioned on the body and communicably coupled to the one or more electromagnetic sensors and the location marking device; and
a power source positioned on the body and providing power to the one or more electromagnetic sensors, the location marking device, and the processing module,
wherein the processing module is programmed to determine one or more characteristics of the one or more casings based on measurement data received by the one or more electromagnetic sensors and autonomously adjust one or more parameters or actions of the casing inspection tool based on the one or more characteristics.

14. The casing inspection tool of claim 13, wherein the processing module comprises a computer system that includes one or more processors and a memory that has stored therein at least one computer program with executable instructions that cause the one or more processors to determine the one or more characteristics of the one or more casings based on the measurement data and autonomously adjust the one or more parameters of the casing inspection tool based on the one or more characteristics.

15. The casing inspection tool of claim 13, wherein the location marking device comprises a magnetic marking device that creates a permanent magnetic mark in the one or more casings.

16. The casing inspection tool of claim 13, wherein the location marking device includes one or more caliper arms that are actuatable to engage an inner wall of the one or more casings.

17. The casing inspection tool of claim 13, further comprising one or more centralizers attached to the body.

18. The casing inspection tool of claim 13, wherein the one or more characteristics of the one or more casings comprises a defect in the one or more casings selected from the group consisting of corrosion, a fracture, a hole, decreased wall thickness, and corrosion of a perforation defined in a wall of at least one of the one or more casings.

19. The casing inspection tool of claim 13, wherein the one or more characteristics comprises a structural characteristic of the one or more casings selected from the group consisting of a number of the one or more casings, and a diameter of at least one of the one or more casings.

20. The casing inspection tool of claim 19, wherein the processing module is further programmed to autonomously deactivate at least one of the one or more electromagnetic sensors or autonomously decrease the power output emitted by the one or more electromagnetic sensors upon determining the structural characteristic of the one or more casings.

21. The casing inspection tool of claim 13, wherein the conveyance comprises slickline.
